(19) United States
(12) Patent Application Publication
(10) Pub. No.: US 2017/0060121 A1
(43) Pub. Date: Mar. 2, 2017

(54) NUMERICAL CONTROLLER

(71) Applicant: FANUC CORPORATION, Yamanashi (JP)

(72) Inventor: Iwao Makino, Yamanashi (JP)

(73) Assignee: FANUC CORPORATION, Yamanashi (JP)

(21) Appl. No.: 15/251,178

(22) Filed: Aug. 30, 2016

(30) Foreign Application Priority Data
Sep. 1, 2015 (JP) 2015-171979

(51) Int. Cl. G05B 19/4155

(52) U.S. Cl. CPC G05B 19/4155; G05B 2219/41047

(57) ABSTRACT

A numerical controller that controls a machine based on a program, the machine including a drive unit that is driven by at least one or more ball screws, includes: instruction program analyzing unit for analyzing the program and generating movement instruction data based on an analysis result; and speed changing unit for evaluating a safe feed speed at a position that is indicated by a coordinate value of the drive unit, based on the coordinate value, and restricting a movement speed of the drive unit up to the safe feed speed, the movement speed of the drive unit being included in the movement instruction data.

### BACKGROUND OF THE INVENTION

1. Field of the Invention

The present invention relates to a numerical controller, and particularly, relates to a numerical controller having a function to control the maximum speed based on the position of a nut threadedly engaged with a ball screw.

2. Description of the Related Art

For a ball screw, there is a critical speed for preventing the breakage due to flexure, and the rapid traverse rate of a drive unit such as a table including a nut threadedly engaged with the ball screw is set to lower than or equal to the critical speed. FIG. 10A and FIG. 10B are diagrams for describing a relation between the position of the nut threadedly engaged with the ball screw and the critical speed. As shown in the figures, a ball screw 1 is threadedly engaged with a nut 2 attached to a table 3, and by the drive of a servomotor 4, the ball screw 1 rotates so that the nut 2 moves. Typically, the critical speed of the nut 2 can be calculated by Formula 1.

$$Nc = \frac{60 {λ}^{2}}{2 π {l}^{2}} \sqrt{\frac{E \times {10}^{3} \cdot I}{γ A}} \qquad [ Formula 1 ]$$

Nc Critical speed (min⁻¹)
l Attachment length (mm)
λCoefficient determined by attachment method for ball screw
   Fixed-Free: λ=1.875
   Supported-Supported: λ=n
   Fixed-Supported: λ=3.927
   Fixed-Fixed: λ=4.730
γ Density (7.85×10⁻⁶ kg/mm³)
A Screw-axial section area (mm²)
E Young's modulus (2.06×10⁵ N/mm²)
I Minimum second moment of screw-axial section area (mm⁴)

As can be seen from Formula 1, the critical speed Nc is inversely proportional to the square of the attachment length l, which is the longer length of the lengths between the respective end parts of the ball screw 1 and the nut 2. When the attachment length l becomes longer, the flexure becomes larger, and therefore, the critical speed Nc becomes lower. That is, when the position of the nut threadedly engaged with the ball screw is near a movement end, the attachment length l between the nut and the other movement end becomes longer, and therefore, the critical speed Nc becomes lower (FIG. 10A), and when the position of the nut is near the center, the attachment lengths between the nut and both movement ends become shorter, and therefore, the critical speed Nc becomes higher (FIG. 10B).

As one conventional technology related to the critical speed, there is a technology of detecting, by position detecting means, whether the position of the nut threadedly engaged with the ball screw is closer to the center or to a movement end, and switching the rapid traverse rate depending on the position of the nut (for example, Japanese Patent Laid-Open No. 03-149157). FIG. 11 shows a rapid traverse rate control method in the technology disclosed in Japanese Patent Laid-Open No. 03-149157. In the technology disclosed in Japanese Patent Laid-Open No. 03-149157, limit switches 5a, 5b are provided at both ends of the ball screw 1, and when either limit switch is turned on, the rapid traverse rate is decreased.

However, in the technology disclosed in Japanese Patent Laid-Open No. 03-149157, the rapid traverse rate is switched at one time in the cycle of the detection of a signal from the position detecting means, and the detection cycle of the signal in the controller is longer compared to the interpolation cycle in the control process for the servomotor and the like. Therefore, there is a problem in that the delay of the signal detection relative to the control process makes it impossible to obtain the highest speed depending on the position of the nut. Further, the position where the rapid traverse rate is switched is the position where the position detecting means such as the limit switch is provided, and therefore, there is a problem in that it is necessary to provide a lot of position detecting means in the case of switching the rapid traverse rate in stages.

Further, for example, in the case of considering a table including multiple axes of a ball screw for the movement in the X-axis direction and a ball screw for the movement in the Y-axis direction, when the table moves by the simultaneous drive of the X-axis and the Y-axis and is at a position close to a movement end of the ball screw on one axis, there is a possibility that the ball screw is broken by the influence of the movement of the other axis, if the rapid traverse rate for the other axis is not set to a low value in concert with that. However, in the technology in Japanese Patent. Laid-Open No. 03-149157, the rapid traverse rate is set independently for each of the multiple axes. Therefore, it is not possible to respond to the above situation, and there is a problem in that all movement axes do not have safe rapid traverse rates.

### SUMMARY OF THE INVENTION

Hence, an object of the present invention is to provide a numerical controller having a function to control the maximum speed based on the position of the nut threadedly engaged with the ball screw.

In the present invention, in the interpolation cycle that is shorter than the detection cycle for the signal, the highest rapid traverse rate that is lower than and equal to the critical speed is set depending on the machine coordinate value. Further, in the case of the simultaneous movement of multiple axes, the rapid traverse rate is set to the speed for an axis having the lowest speed.

Then, a numerical controller according the present invention is a numerical controller that controls a machine based on a program, the machine including a drive unit that is driven by at least one or more ball screws, the numerical controller including: instruction program analyzing means for analyzing the program and generating movement instruction data based on an analysis result; and speed changing means for evaluating a safe feed speed at a position that is indicated by a coordinate value of the drive unit on the ball screw, based on the coordinate value of the drive unit, and restricting a movement speed of the drive unit up to the safe feed speed, the movement speed of the drive unit being included in the movement instruction data.

The numerical controller may further include attachment length information setting means in which attachment length information is previously set, the attachment length information indicating a correspondence relation between the coordinate value of the drive unit and an attachment length, the attachment length indicating a length between an end part of the ball screw and the drive unit, and the speed changing means may evaluate the attachment length at the position that is indicated by the coordinate value of the drive unit, based on the coordinate value of the drive unit and the attachment length information set in the attachment length information setting means, and may evaluate the safe feed speed at the position that is indicated by the coordinate value of the drive unit, based on the attachment length.

The numerical controller may further include reference speed setting means in which multiple pieces of reference speed information are previously set, the reference speed information associating a speed changing point with a safe reference speed, the speed changing point being an arbitrary coordinate value of the drive unit, the safe reference speed being a reference speed that is lower than a critical speed at the speed changing point, and the speed changing means may evaluate the safe feed speed at the position that is indicated by the coordinate value of the drive unit, based on the coordinate value of the drive unit and the reference speed information set in the reference speed setting means.

The speed changing means may evaluate safe feed speeds of the drive unit for all ball screws that drive the drive unit, and may restrict movement speeds of the drive unit for all ball screws up to a safe feed speed that is the lowest speed of the safe feed speeds.

According to the present invention, the highest rapid traverse rate can be set depending on the machine coordinate value. Therefore, the cycle time can be shortened, and the position detecting means is unnecessary. Further, in the simultaneous movement of multiple axes, it is possible to set a safe and highest rapid traverse rate.

### BRIEF DESCRIPTION OF THE DRAWINGS

The above-described and other objects and features of the present invention will be obvious from the description of the following embodiments, with reference to the accompanying drawings. In the drawings:

FIG. 1 is a functional block diagram of a numerical controller in a first embodiment of the present invention;

FIG. 2 is a diagram showing an example of the setting of a safe rapid traverse rate 1 (RF₁) in the first embodiment of the present invention;

FIG. 3 is a diagram showing an example of the setting of a lower limit safe speed Fl based on safe rapid traverse rates 1 (RF₁) for multiple axes in the first embodiment of the present invention;

FIG. 4 is a flowchart of a speed conversion process in the first embodiment of the present invention;

FIG. 5 is a functional block diagram of a numerical controller in a second embodiment of the present invention;

FIG. 6 is a diagram showing an example of the setting of a safe rapid traverse rate 2 (RF₂) in the second embodiment of the present invention;

FIG. 7 is a diagram showing a specific example of the evaluation of speed changing points Pm, Pp based on a machine coordinate value Pc in the second embodiment of the present invention;

FIG. 8 is a diagram showing an example of the setting of a lower limit safe speed Fl based on safe rapid traverse rates 2 (RF₂) for multiple axes in the second embodiment of the present invention;

FIG. 9 is a flowchart of a speed conversion process in the second embodiment of the present invention;

FIG. 10A is a diagram for describing a relation between the position of a nut threadedly engaged with a ball screw and the critical speed, and is a diagram showing a case where one attachment length is long;

FIG. 10B is a diagram for describing a relation between the position of the nut threadedly engaged with the ball screw and the critical speed, and is a diagram showing a case where attachment lengths are short; and

FIG. 11 is a diagram for describing a rapid traverse rate control method in a conventional technology.

### DETAILED DESCRIPTION OF THE PREFERRED EMBODIMENTS

Hereinafter, embodiments of the present invention will be described with the drawings.

In the present invention, the highest rapid traverse rate that is lower than or equal to the critical speed is set depending on the machine coordinate value of a drive unit that is driven by a ball screw. The machine coordinate value can be acquired by an internal process in the numerical controller, and therefore, can be acquired in the interpolation cycle that is shorter than the detection cycle for the signal, allowing for the setting of the rapid traverse rate without the delay relative to the control process. Further, it is unnecessary to provide special constituents such as limit sensors.

Furthermore, in the present invention, in the case of the movement by the simultaneous drive of multiple ball screws, the rapid traverse rate is set to the speed for an axis having the lowest speed. Thereby, even in the case of the simultaneous drive of the multiple ball screws, a safe rapid traverse rate is set for all ball screws, allowing for the safe drive of the machine without the breakage of the ball screws.

### First Embodiment

In a first embodiment, the rapid traverse rate is set to a safe rapid traverse rate 1 (RF₁) resulting from multiplying a critical speed Nc evaluated from a general formula such as the above Formula 1, by a safety coefficient Ks.

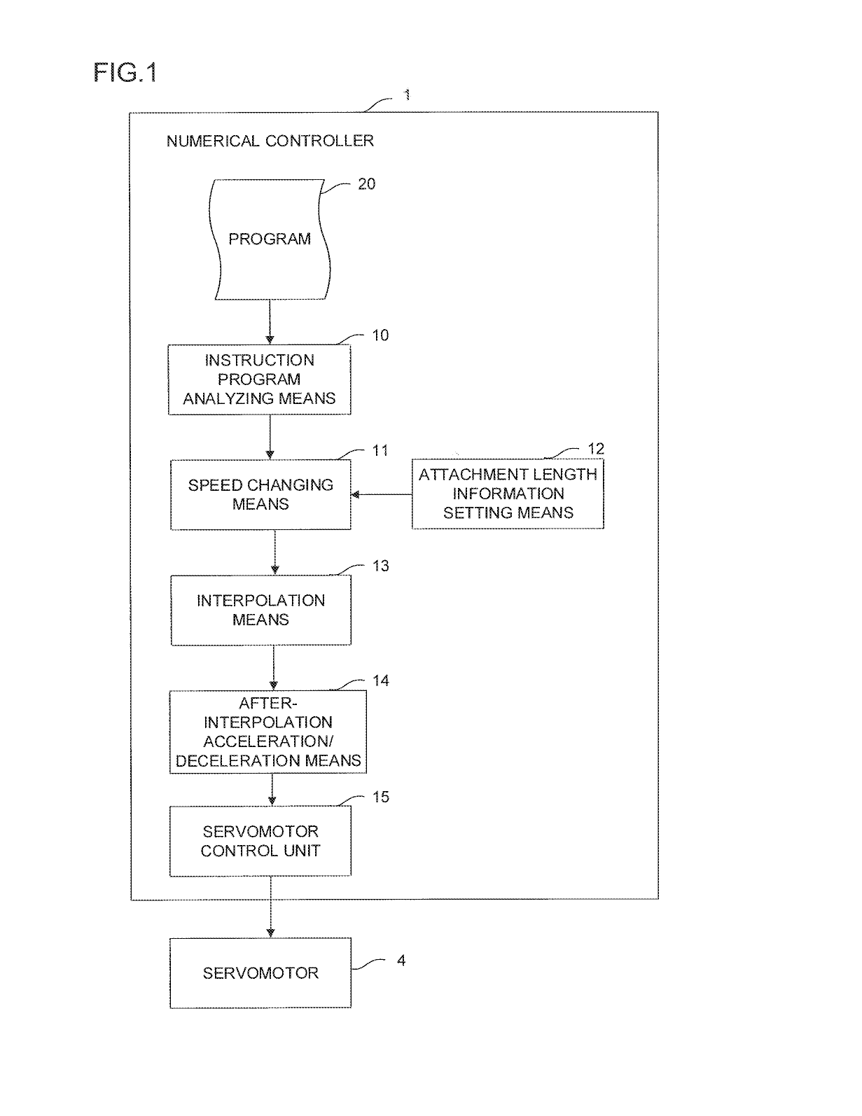

FIG. 1 is a functional block diagram of a numerical controller in the embodiment. A numerical controller 1 in the embodiment includes instruction program analyzing means 10, speed changing means 11, attachment length information setting means 12, interpolation means 13, after-interpolation acceleration/deceleration, means 14, and a servomotor control unit 15.

The instruction program analyzing means 10 analyzes a program 20 that is stored in a non-illustrated memory or the like and that is input from non-illustrated MDI/display means or the like, and based on the analysis result, generates the movement instruction data for each axis of a machine that is a control object.

The speed changing means 11, which is function means for implementing the technology of the present invention, acquires the machine coordinate value of a drive unit to be driven by ball screws included in the machine that is a control object, and restricts the rapid traverse rates of the ball screws based on the machine coordinate value. The speed changing means 11 calculates the attachment length l in Formula 1 from the machine coordinate value, based on the attachment length information indicating the correspondence relation between the attachment length l and the machine coordinate value, which is previously set in the attachment length information setting means 12 by a manufacturer, an operator or the like, calculates the safe rapid traverse rate 1 (RF₁) based on the calculated attachment length l, and sets a lower limit safe speed Fl to a safe rapid traverse rate 1 (RF₁) that is lowest among the movement axes. The setting procedure for the lower limit safe speed Fl is shown as follows.

(Setting Procedure 1) The safe rapid traverse rate 1 (RF₁) at the current machine coordinate is calculated for each axis, based on a parameter set in the attachment length information setting means 12 and the following Formula 2.
(Setting Procedure 2) The lower limit safe speed Fl is set to a safe rapid traverse rate 1 (RF₁) that is lowest among the movement axes.

RF₁=Nc×Ks

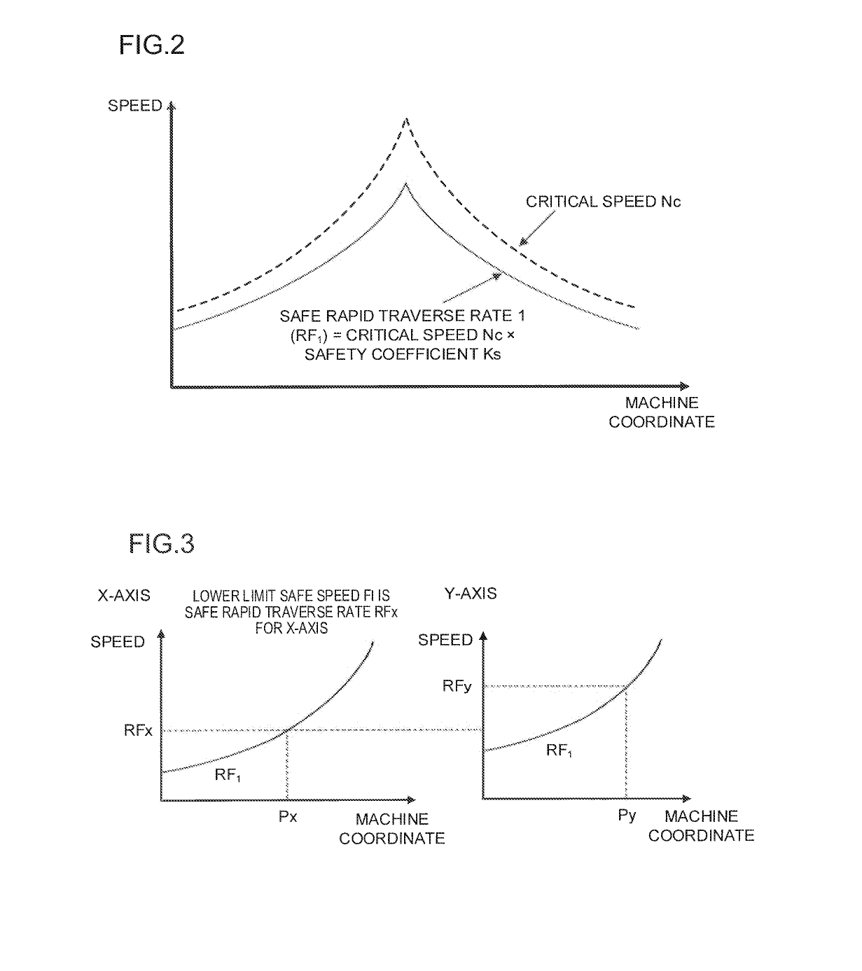

FIG. 2 is a diagram showing an example of the setting of the safe rapid traverse rate 1 (RF₁) using the safety coefficient Ks in Setting Procedure 1, and FIG. 3 is a diagram showing an example of the setting of the lower limit safe speed Fl in the case of a safe rapid traverse rate RFx at a machine coordinate Px on the X-axis and a safe rapid traverse rate RFy at a machine coordinate Py on the Y-axis in Setting Procedure 2. In the example of FIG. 3, the safe rapid traverse rate RFx for the X-axis is lower than the safe rapid traverse rate RFy for the Y-axis, and therefore, the lower limit safe speed Fl is the safe rapid traverse rate RFx for the X-axis. Here, the safe rapid traverse rate 1 (RF₁) may be different between the X-axis and the Y-axis.

The speed changing means 11 performs the setting such that the rapid traverse rate for each ball screw is lower than or equal to the lower limit safe speed Fl, based on the lower limit safe speed Fl set as a result of performing the above setting procedure for all axes. Since the process of the above setting procedure is performed in the interpolation cycle, the lower limit safe speed Fl changes smoothly, and in concert with that, the rapid traverse rate of the ball screw also, which is restricted by the lower limit safe speed Fl, changes smoothly.

Here, the attachment length information previously set in the attachment length information setting means 12 may be, for example, a function indicating the correspondence relation between the machine coordinate value and the attachment length, and a parameter therefor. Further, in the setting of the rapid traverse rate by the safe rapid traverse rate 1 (RF₁), the enabled state and the disabled state may be designated by a G code in the NC program, or the switching between the enabled state and the disabled state may be performed based on a signal from the exterior.

The interpolation means 13 generates the data resulting from performing the interpolation calculation of the point on the instructed path in the interpolation cycle, based on the movement instruction given by the movement instruction data after the speed computation that is output by the speed changing means 11.

The after-interpolation acceleration/deceleration means 14 performs the acceleration/deceleration process based on the interpolation data output by the interpolation means 13, calculates the speed for each drive axis in the interpolation cycle, and outputs the resulting data to the servomotor control unit 15.

Then, the servomotor control unit 15 controls each drive unit of the machine, based on the output from the after-interpolation acceleration/deceleration means 14.

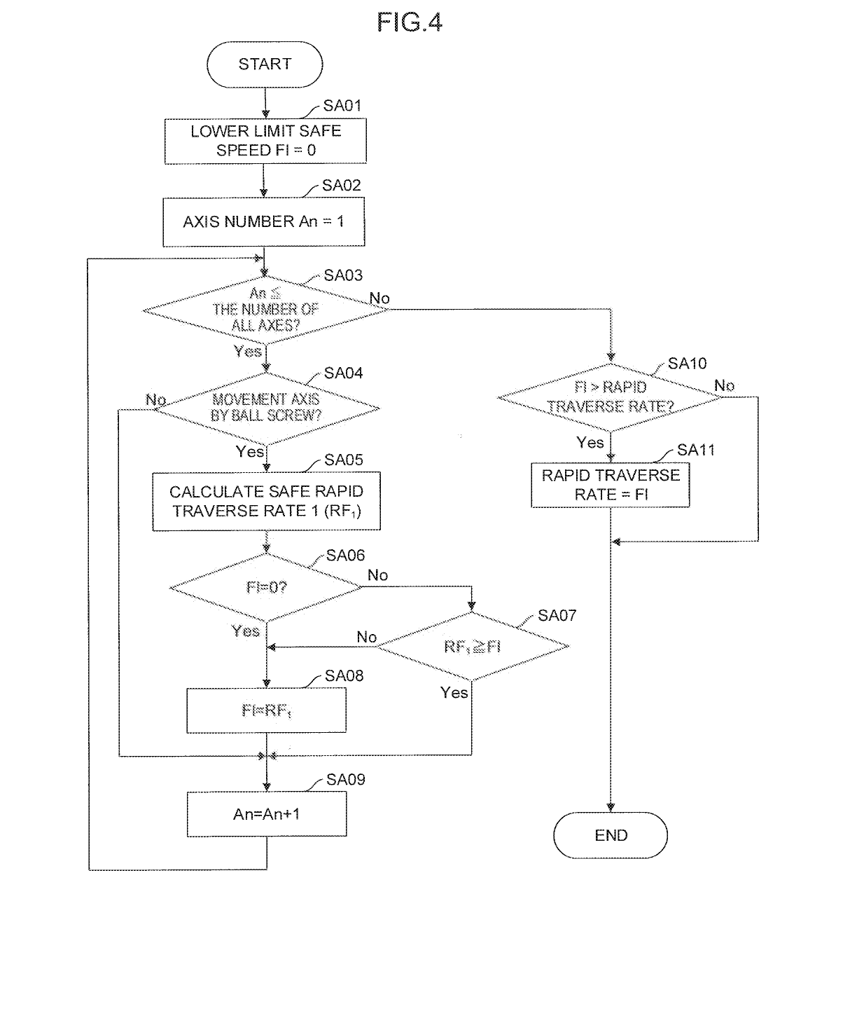

FIG. 4 is a flowchart of a speed conversion process that is executed by the speed changing means 11 in the embodiment.

[SA01] The lower limit safe speed Fl is set to 0.
[Step SA02] An axis number An is set to 1.
[Step SA03] Whether the axis number An is less than or equal to the number of all axes is judged. In the case of being less than or equal to the number of all axes, there is still an axis for which the safe rapid traverse rate 1 is not calculated, and therefore, the process proceeds to step SA04. In the case of exceeding the number of all axes, the calculation of the safe rapid traverse rate 1 is completed for all axes, and therefore, the process proceeds to step SA10.
[Step SA04] Whether the axis indicated by the axis number An is a movement axis by the ball screw is judged. In the case of a movement axis by the ball screw, the process proceeds to step SA05. Otherwise, the process proceeds to step SA09.
[Step SA05] For the axis indicated by the axis number An, the safe rapid traverse rate 1 (RF₁) is calculated using Formula 1 and Formula 2.
[Step SA06] Whether the lower limit safe speed Fl is 0 is judged. In the case where the lower limit safe speed Fl is 0, the process proceeds to step SA08. Otherwise, the process proceeds to step SA07.
[Step SA07] Whether the safe rapid traverse rate 1 (RF₁) calculated in step SA05 is higher than the lower limit safe speed Fl is judged. In the case where the safe rapid traverse rate 1 (RF₁) is higher than the lower limit safe speed Fl, the process proceeds to step SA09. Otherwise, the process proceeds to step SA08.
[Step SA08] The lower limit safe speed Fl is updated (set) to the safe rapid traverse rate 1 (RF₁).
[Step SA09] The axis number An is incremented by 1, and then the process returns to step SA03.
[Step SA10] Whether the lower limit safe speed Fl set in step SA08 is higher than the rapid traverse rate is judged. In the case where the lower limit safe speed Fl is higher than the rapid traverse rate, the process proceeds to step SA11. Otherwise, the process is ended.
[Step SA11] The rapid traverse rate is set to the lower limit safe speed Fl.

Thus, the numerical controller 1 described in the embodiment includes the speed changing means 11 for setting the highest rapid traverse rate depending on the machine coordinate value. Therefore, the highest rapid traverse rate can be quickly set in the interpolation cycle, the cycle time can be shortened compared to the conventional technology, and the position detecting means is unnecessary. Further, in the simultaneous movement of multiple axes, it is possible to set a safe and highest rapid traverse rate.

### Second Embodiment

In the first embodiment, there has been shown an example of setting the rapid traverse rate to the safe rapid traverse rate 1 (RF₁) resulting from multiplying the critical speed Nc by the safety coefficient Ks. In a second embodiment, there is shown an example of setting a speed changing point that is an arbitrary machine coordinate value of the drive unit to be driven by the ball screw, and setting the rapid traverse rate using the speed changing point and a safe reference speed.

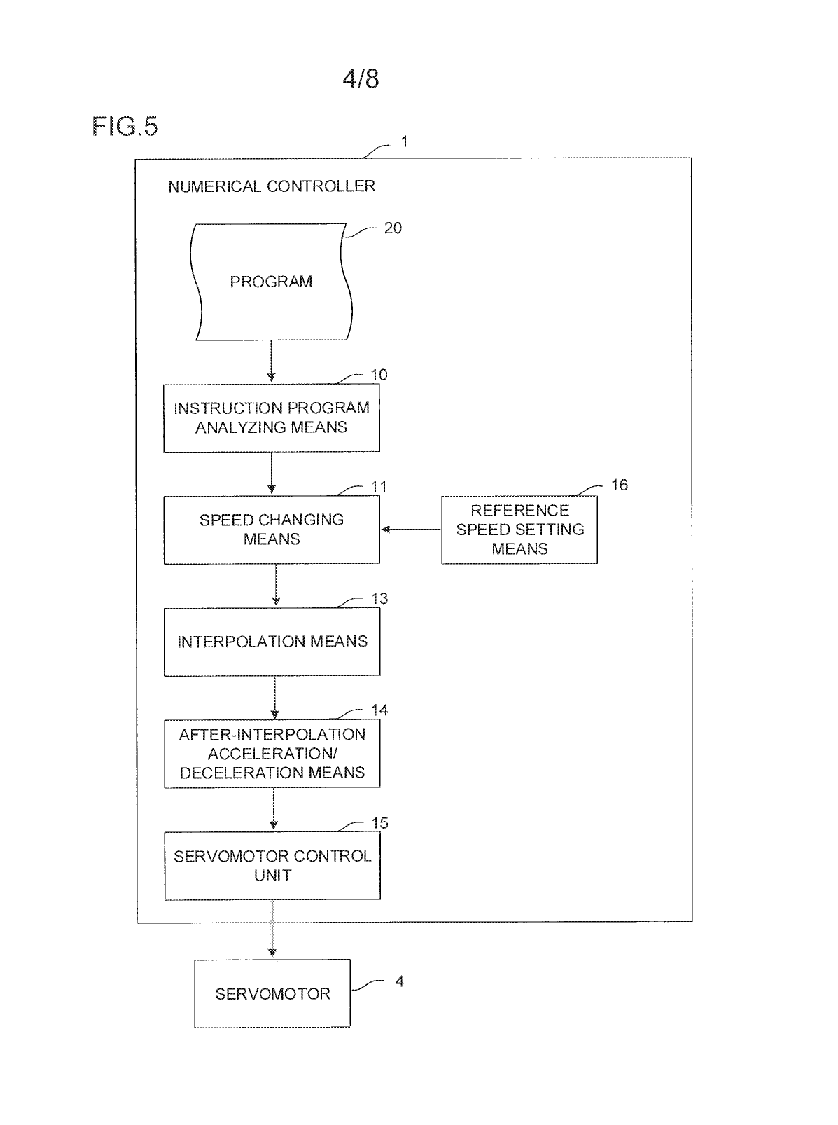

FIG. 5 is a functional block diagram of a numerical controller in the embodiment. A numerical controller 1 in the embodiment is different from the first embodiment in that a reference speed setting means 16 is included.

In the reference speed setting means 16, speed changing points (P1, P2, . . . ) that are arbitrary machine coordinate values of the drive unit to be driven by ball screws, and safe reference speeds (SF1, SF2, . . . ) that are reference speeds lower than the critical speeds at the speed changing points are previously stored as parameters, for example, by the setting by a manufacturer, an operator or the like. Multiple speed changing points and safe reference speeds can be set for each axis.

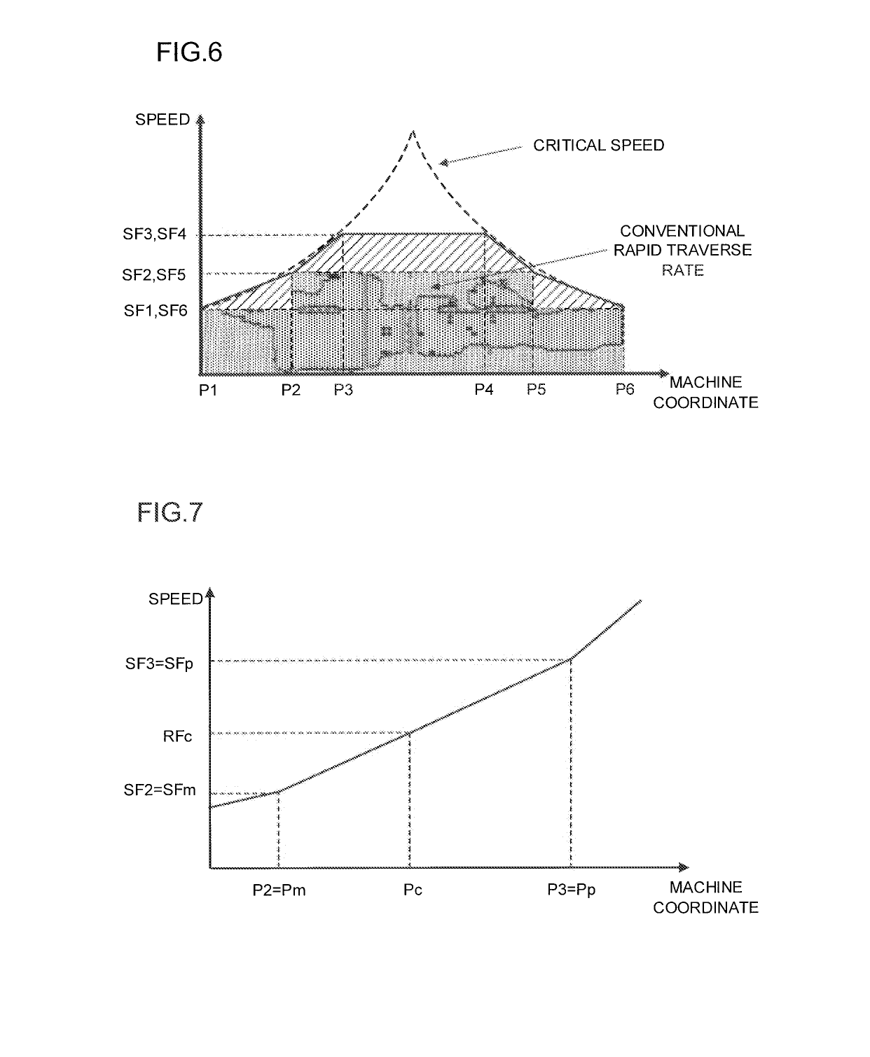

FIG. 6 is a diagram for describing the speed changing points and safe reference speeds that are set in the embodiment. In the example shown in FIG. 6, P1 to P6 are set as the speed changing points, and SF1, SF2, . . . are set as the safe reference speed at P1, the safe reference speed at P2, . . . , respectively.

The safe reference speeds at the respective speed changing points are set to reference speeds that are lower than the critical speeds at the speed changing points, and SF1=SF6, SF2=SF5 and SF3=SF4 are satisfied so that three levels of safe reference speeds are set. Here, in FIG. 6, the dot-shaded portion is the range of the safe rapid traverse rate in the conventional technology, and the portion in which the dot-shaded portion and the diagonal line-shaded portion are added is the range of the safe rapid traverse rate in the embodiment.

Based on the machine coordinate value Pc of the drive unit to be driven by ball screws included in a machine that is a control object and the speed changing points and safe reference speeds set in the reference speed setting means 16, the speed changing means 11 in the embodiment calculates safe rapid traverse rates 2 (RF₂) at the machine coordinate value Pc, and sets the lower limit safe speed Fl to a safe rapid traverse rate 2 (RF₂) that is lowest among the movement axes.

The setting procedure for the lower limit safe speed Fl is shown as follows.

(Setting Procedure 1) With respect to the machine coordinate value Pc, a speed changing point Pm on the minus side and a speed changing point Pp on the plus side are evaluated. FIG. 7 shows an example in which Pc is between P2 and P3. P2 is Pm on the minus side, and P3 is Pp on the plus side.
(Setting Procedure 2) The safe rapid traverse rate RF₂ at the machine coordinate value Pc is calculated from the following Formula 3, using a safe reference speed SFm at the speed changing point Pm and a safe reference speed SFp at the speed changing point Pp. For example, in the case where the machine coordinate value Pc is between P2 and P3, the safe rapid traverse rate RF₂ can be calculated from the following Formula 4.
(Setting Procedure 3) The lower limit safe speed Fl is set to a safe rapid traverse rate RF₂ that is lowest among the movement axes of the ball screws.

$$\begin{matrix}{RF}_{2} = SFm + \frac{SFp - SFm}{Pp - Pm} ( Pc - Pm ) & [ Formula 3 ] \\ {RF}_{2} = SF 2 + \frac{SF 3 - SF 2}{P 3 - P 2} ( P 3 - P 2 ) & [ Formula 4 ]\end{matrix}$$

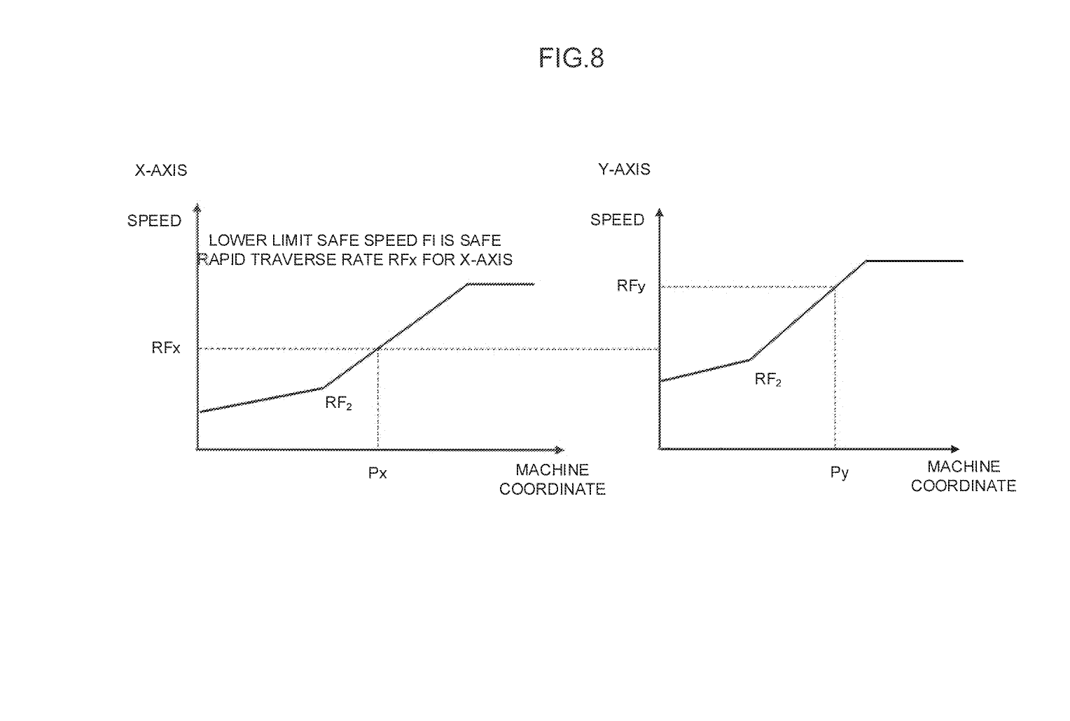

FIG. 8 is a diagram showing an example of the setting of the lower limit safe speed Fl in the case of a safe rapid traverse rate RFx at a machine coordinate Px on the X-axis and a safe rapid traverse rate RFy at a machine coordinate Py on the Y-axis in Setting Procedure 2. In the example of FIG. 8, the safe rapid traverse rate RFx for the X-axis is lower than the safe rapid traverse rate RFy for the Y-axis, and therefore, the lower limit safe speed Fl is the safe rapid traverse rate RFx for the X-axis. Here, the safe rapid traverse rate RF₂ may be different between the X-axis and the Y-axis.

The speed changing means 11 performs the setting such that the rapid traverse rate for each ball screw is lower than or equal to the lower limit safe speed Fl, based on the lower limit safe speed Fl set as a result of performing the above setting procedure for all axes. Since the process of the above setting procedure is performed in the interpolation cycle, the lower limit safe speed Fl changes smoothly, and in concert with that, the rapid traverse rate of the ball screw also, which is restricted by the lower limit safe speed Fl, changes smoothly.

Here, in the setting of the rapid traverse rate by the safe rapid traverse rate 2 (RF₂), the enabled state and the disabled state may be designated by a G code in the NC program, or the switching between the enabled state and the disabled state may be performed based on a signal from the exterior.

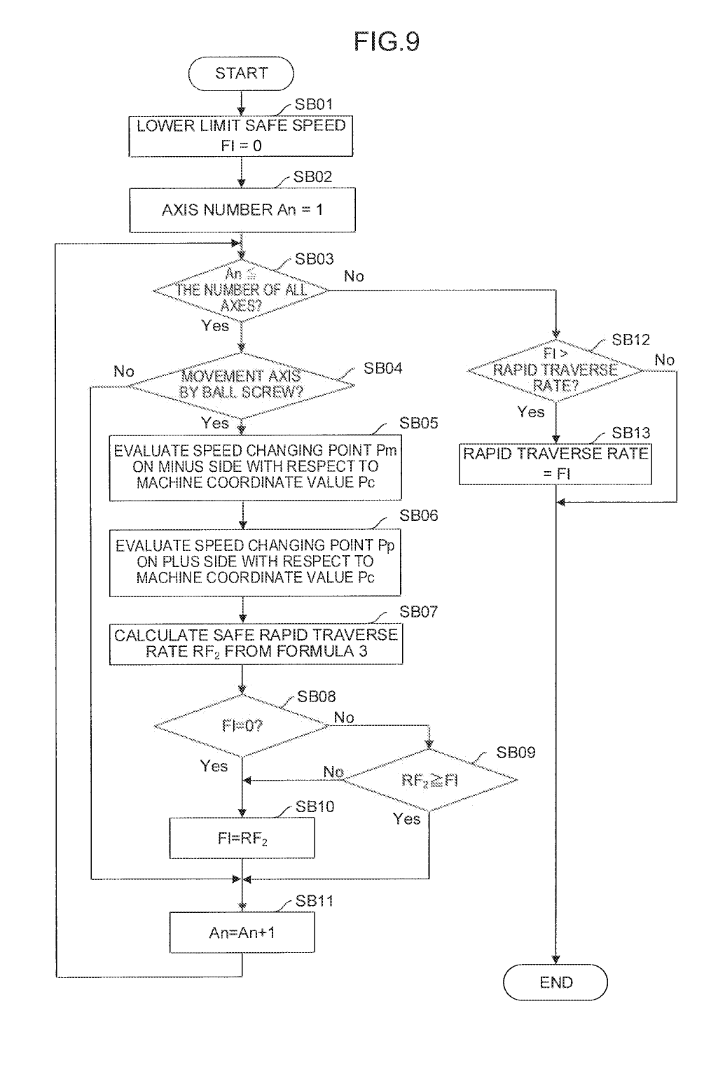

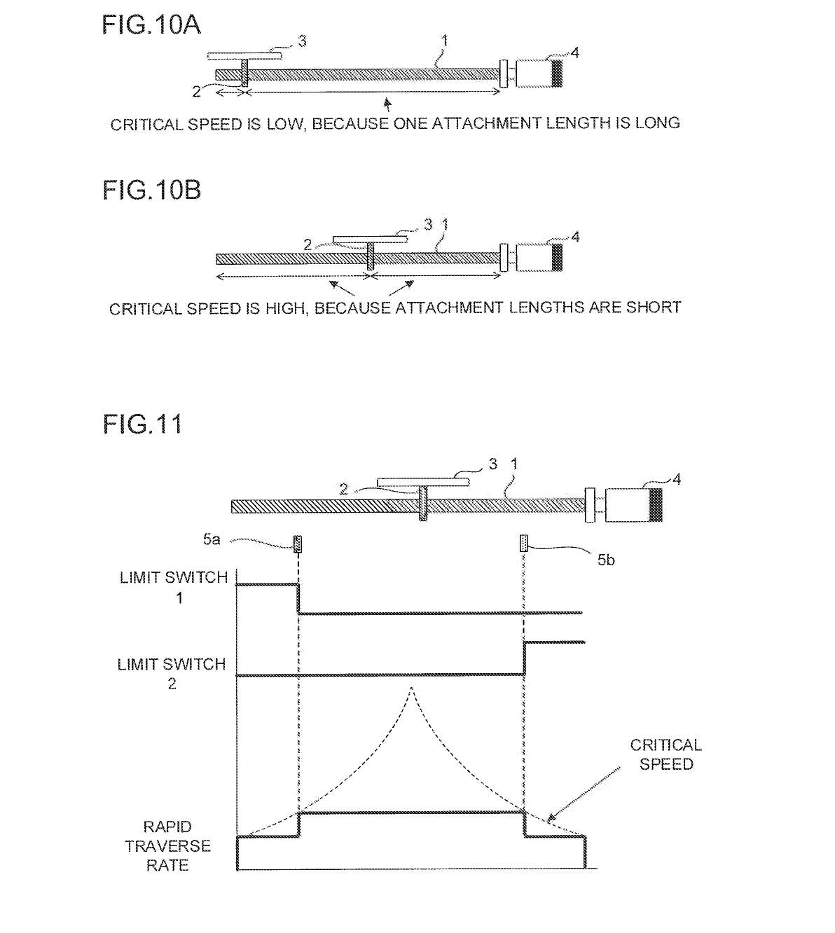

FIG. 9 is a flowchart of a speed conversion process that is executed by the speed changing means 11 in the embodiment.

[Step SB01] The lower limit safe speed Fl is set to 0.
[Step SB02] The axis number An is set to 1.
[Step SB03] Whether the axis number An is less than or equal to the number of all axes is judged. In the case of being less than or equal to the number of all axes, there is still an axis for which the safe rapid traverse rate 2 is not calculated, and therefore, the process proceeds to step SB04. In the case of exceeding the number of all axes, the calculation of the safe rapid traverse rate 2 is completed for all axes, and therefore, the process proceeds to step SB12.
[Step SB04] Whether the axis indicated by the axis number An is a movement axis by the ball screw is judged. In the case of a movement axis by the ball screw, the process proceeds to step SB05. Otherwise, the process proceeds to step SB11.
[Step SB05] The speed changing point Pm on the minus side with respect to the machine coordinate value Pc on the axis indicated by the axis number An is evaluated based on the reference speed setting means 16.
[Step SB06] The speed changing point Pp on the plus side with respect to the machine coordinate value Pc on the axis indicated by the axis number An is evaluated based on the reference speed setting means 16,
[Step SB07] The safe rapid traverse rate 2 (RF₂) is calculated using Formula 3, based on the speed changing point Pm evaluated in step SB05, the speed changing point Pp evaluated in step SB06 and the safe reference speed set in the reference speed setting means 16.
[Step SB08] Whether the lower limit safe speed Fl is 0 is judged. In the case where the lower limit safe speed Fl is 0, the process proceeds to step SB10. Otherwise, the process proceeds to step SB09.
[Step SB09] Whether the safe rapid traverse rate 2 (RF₂) calculated in step SB07 is higher than the lower limit safe speed Fl is judged. In the case where the safe rapid traverse rate 2 (RF₂) is higher than the lower limit safe speed Fl, the process proceeds to step SB11. Otherwise, the process proceeds to step SB10.
[Step SB10] The lower limit safe speed Fl is updated (set) to the safe rapid traverse rate 2 (RF₂).
[Step SB11] The axis number An is incremented by 1, and then the process returns to step SB03.
[Step SB12] Whether the lower limit safe speed Fl set in step SB10 is higher than the rapid traverse rate is judged. In the case where the lower limit safe speed Fl is higher than the rapid traverse rate, the process proceeds to step SB13. Otherwise, the process is ended.
[Step SB13] The rapid traverse rate is set to the lower limit safe speed Fl.

Thus, the numerical controller 1 described in the embodiment includes the speed changing means 11 for setting the highest rapid traverse rate depending on the machine coordinate value. Therefore, the highest rapid traverse rate can be quickly set in the interpolation cycle, the cycle time can be shortened compared to the conventional technology, and the position detecting means is unnecessary. Further, in the simultaneous movement of multiple axes, it is possible to set a safe and highest rapid traverse rate.

So far, the embodiments of the present invention have been described. The present invention is not limited to only the examples in the above-described embodiments, and can be carried out in various modes, with appropriate modifications.

For example, in the above embodiments, there are shown examples in which the technology of the present invention is applied to the setting of the rapid traverse rate, but the technology may be used for the setting of the maximum cutting feedrate in cutting.

Further, in the above embodiments, there are shown examples in which the attachment length information setting means 12 and the reference speed setting means 16 are configured as separate function means from the speed changing means 11, but the attachment length information setting means 12 and the reference speed setting means 16 may be implemented as internal processes in the speed changing means 11.

Furthermore, the above embodiments adopt a configuration in which the safe feed speed is evaluated based on the machine coordinate value, but the safe feed speed may be evaluated based on a coordinate value allowing for the interconversion with the machine coordinate value, for example, based on a work coordinate value.

Thus, the embodiments of the present invention have been described. The present invention is not limited to the examples in the above-described embodiments, and can be carried out in other modes, with appropriate modifications.

1. A numerical controller that controls a machine based on a program, the machine including a drive unit that is driven by at least one or more ball screws,
the numerical controller comprising:
instruction program analyzing unit for analyzing the program and generating movement instruction data based on an analysis result; and
speed changing unit for evaluating a safe feed speed at a position that is indicated by a coordinate value of the drive unit on the ball screw, based on the coordinate value of the drive unit, and restricting a movement speed of the drive unit up to the safe feed speed, the movement speed of the drive unit being included in the movement instruction data.

2. The numerical controller according to claim 1, further comprising attachment length information setting unit in which attachment length information is previously set, the attachment length information indicating a correspondence relation between the coordinate value of the drive unit and an attachment length, the attachment length indicating a length between an end part of the ball screw and the drive unit,
wherein the speed changing unit evaluates the attachment length at the position that is indicated by the coordinate value of the drive unit, based on the coordinate value of the drive unit and the attachment length information set in the attachment length information setting unit, and evaluates the safe feed speed at the position that is indicated by the coordinate value of the drive unit, based on the attachment length.

3. The numerical controller according to claim 1, further comprising reference speed setting unit in which multiple pieces of reference speed information are previously set, the reference speed information associating a speed changing point with a safe reference speed, the speed changing point being an arbitrary coordinate value of the drive unit, the safe reference speed being a reference speed that is lower than a critical speed at the speed changing point,
wherein the speed changing unit evaluates the safe feed speed at the position that is indicated by the coordinate value of the drive unit, based on the coordinate value of the drive unit and the reference speed information set in the reference speed setting unit.

4. The numerical controller according to claim 1,
wherein the speed changing unit evaluates safe feed speeds of the drive unit for all ball screws that drive the drive unit, and restricts movement speeds of the drive unit for all ball screws up to a safe feed speed that is the lowest speed of the safe feed speeds.

5. The numerical controller according to claim 2,
wherein the speed changing unit evaluates safe feed speeds of the drive unit for all ball screws that drive the drive unit, and restricts movement speeds of the drive unit for all ball screws up to a safe feed speed that is the lowest speed of the safe feed speeds.

6. The numerical controller according to claim 3,
wherein the speed changing unit evaluates safe feed speeds of the drive unit for all ball screws that drive the drive unit, and restricts movement speeds of the drive unit for all ball screws up to a safe feed speed that is the lowest speed of the safe feed speeds.
